(19) United States
(12) Patent Application Publication
(10) Pub. No.: US 2013/0339013 A1
(43) Pub. Date: Dec. 19, 2013

(54) PROCESSING APPARATUS, PROCESSING SYSTEM, AND OUTPUT METHOD

(71) Applicants: Haruomi Higashi, Kanagawa (JP); Hideki Ohhashi, Kanagawa (JP); Tomoyuki Tsukuda, Kanagawa (JP); Takahiro Hiramatsu, Kanagawa (JP)

(72) Inventors: Haruomi Higashi, Kanagawa (JP); Hideki Ohhashi, Kanagawa (JP); Tomoyuki Tsukuda, Kanagawa (JP); Takahiro Hiramatsu, Kanagawa (JP)

(73) Assignee: Ricoh Company, Ltd., Tokyo (JP)

(21) Appl. No.: 13/916,733

(22) Filed: Jun. 13, 2013

(30) Foreign Application Priority Data
Jun. 15, 2012 (JP) 2012-136097

(51) Int. Cl. G10L 15/08

(52) U.S. Cl. CPC G10L 15/08
USPC 704/231

(57) ABSTRACT

A processing apparatus includes: a search result acquisition unit that acquires a search result searched based on a voice of a user recognized by a voice recognition unit; a user data storage unit that stores therein a knowledge level so as to be associated with a user; an expression data storage unit that stores therein a plurality of pieces of expression data expressing provision contents provided to the user as the search result so as to be associated with a plurality of different knowledge levels, the plurality of pieces of expression data having different professional levels; a knowledge level identifying unit that identifies a knowledge level of the user with reference to the user data storage unit; an editing unit that edits the search result based on the expression data associated with the identified knowledge level; and an output unit that outputs the edited search result.

### CROSS-REFERENCE TO RELATED APPLICATIONS

The present application claims priority to and incorporates by reference the entire contents of Japanese Patent Application No. 2012-136097 filed in Japan on Jun. 15, 2012.

### BACKGROUND OF THE INVENTION

1. Field of the Invention

The present invention relates to a processing apparatus, a processing system, and an output method.

2. Description of the Related Art

Conventionally, conversation apparatuses have been known that identify real-time personalities of users and change behaviors of character agents in accordance with the identified personalities so as to enable the users and the apparatuses to have smoother conversation. The personalities are obtained by quantifying moods or psychological states of the users. As an example of such conversation apparatuses, an apparatus is disclosed in Japanese Patent Application Laid-open No. 2005-196645, in which the apparatus evaluates, for example, whether the user is in a dominative personality state or a submissive personality state on the basis of display time information relating to a time period in which an agent is displayed to the user, difficulty of an answer to a question, and the personality obtained from a measurement result of a voice processing device or the like.

However, for example, there is a user who can understand the content of the term “EC” from only this expression whereas there is another user who cannot understand the content unless a supplementary explanation, such as “business performed on the Internet”, is provided. There is still another user who can understand the content when “electronic commerce”, which is the full spelling of “EC”, or the corresponding term in Japanese is provided, and needs no supplementary explanation.

When the supplementary explanation described above is provided to a person who can understand “EC”, the explanation is bothersome for the person. On the other hand, when highly-professional information such as “EC” is simply provided to a person who needs a supplementary explanation, the person cannot understand the content. In this way, the provision of information not fitting the knowledge level of a person in a conversation hinders smooth conversation.

In such circumstances, the conventional technique has a problem in that information cannot be provided to a user in an expression fitting to the user's knowledge level because the user's knowledge level is not taken into consideration.

In view of such circumstances, there is a need to provide a processing apparatus, a processing system, and an output method that can provide a user with information in an expression fitting the user's knowledge level.

### SUMMARY OF THE INVENTION

It is an object of the present invention to at least partially solve the problems in the conventional technology.

A processing apparatus includes: a voice recognition unit that recognizes a voice of a user; a search result acquisition unit that acquires a search result searched on the basis of the voice recognized by the voice recognition unit; a user data storage unit that stores therein a knowledge level in a predetermined knowledge field so as to be associated with a user; an expression data storage unit that stores therein a plurality of pieces of expression data expressing provision contents provided to the user as the search result so as to be associated with a plurality of different knowledge levels, the plurality of pieces of expression data having different professional levels regarding the provision contents; a knowledge level identifying unit that identifies a knowledge level of the user with reference to the user data storage unit; an editing unit that edits the search result on the basis of the expression data associated with the knowledge level identified by the knowledge level identifying unit in the expression data storage unit and expressing the provision contents included in the search result acquired by the search result acquisition unit; and an output unit that outputs the search result after being edited by the editing unit.

A processing system includes: a voice recognition unit that recognizes a voice of a user; a search result acquisition unit that acquires a search result searched on the basis of the voice recognized by the voice recognition unit; a user data storage unit that stores therein a knowledge level in a predetermined knowledge field so as to be associated with a user; an expression data storage unit that stores therein a plurality of expressions expressing provision contents provided to the user as the search result so as to be associated with a plurality of different knowledge levels, the plurality of pieces of expressions having different professional levels regarding the provision contents; a knowledge level identifying unit that identifies a knowledge level of the user with reference to the user data storage unit; an editing unit that edits the search result on the basis of expression data associated with the knowledge level identified by the knowledge level identifying unit in the expression data storage unit and expressing the provision contents included in the search result acquired by the search result acquisition unit; and an output unit that outputs the search result after being edited by the editing unit.

An output method is performed by a processing apparatus that includes a user data storage unit that stores therein a knowledge level in a predetermined knowledge field so as to be associated with a user, and an expression data storage unit that stores therein a plurality of expressions expressing the provision contents provided to the user so as to be associated with a plurality of different knowledge levels, the plurality of expressions having different professional levels regarding provision contents. The output method includes: recognizing a voice of a user; acquiring a search result searched on the basis of the voice recognized at the recognizing; identifying a knowledge level of the user with reference to the user data storage unit; editing the search result on the basis of the expression data that is associated with the knowledge level identified at the identifying in the expression data storage unit and expresses the provision contents included in the search result acquired at the acquiring; and outputting the search result after being edited at the editing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an exemplary structure of a processing system;

FIG. 2 is a block diagram illustrating detailed functional structures of a storage unit and a control unit;

FIG. 3 is a schematic diagram illustrating a data structure of a professional attribute table;

FIG. 4 is a schematic diagram illustrating a data structure of an activity information table;

FIG. 5 is a schematic diagram illustrating a data structure of an expression data table;

FIG. 6 is a schematic diagram for explaining processing performed by a user dictionary management unit;

FIG. 7 is a flowchart illustrating an example of first search processing;

FIG. 8 is a flowchart illustrating an example of second search processing; and

FIG. 9 is a schematic diagram illustrating examples of the explanation contents of the term “DNS” obtained as a search result.

### DETAILED DESCRIPTION OF THE PREFERRED EMBODIMENT

Embodiments of a processing apparatus, a processing system, and an output method are described below in detail with reference to the accompanying drawings.

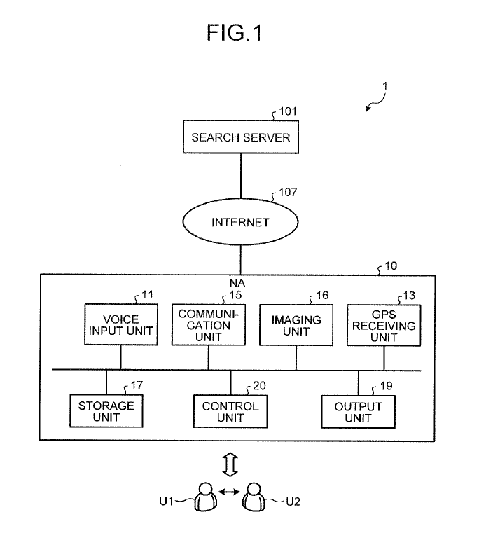

FIG. 1 is a block diagram illustrating an exemplary structure of a processing system 1 in the present embodiment. As illustrated in FIG. 1, the processing system 1 includes a network agent (NA) 10 as an example of the processing apparatus and a search server 101 and supports conversation between users U1 and U2 using a web cloud including the search server 101. The NA 10 and the search server 101 are connected through the Internet 107.

The search server 101 is to search information published on the web, and may be a server that provides a search engine function on the web, for example. Specifically, the search server 101 receives a search query from the NA 10, searches information published on the web in accordance with the received search query, and transmits the search result to the NA 10. The information that the search server 101 searches may be dynamic information published on dynamic web pages or static information published on static web pages. In the example illustrated in FIG. 1, the single search server 101 is exemplarily illustrated. However, not limited thereto, and any number of servers may be included.

The NA 10 is a terminal that accesses information or functions published on the web. In the embodiment, it is assumed that the NA 10 is a mobile terminal such as a smartphone or a tablet. The NA 10, however, is not limited to the mobile terminal. Any device accessible to the Internet can be used as the NA 10.

In the embodiment, the description of the NA 10 (processing system 1) is made on the basis of an assumption that the user U1 has the NA 10 and uses the NA 10 for having conversation with the user U2. However, a user can use the NA 10 alone or more than two users can use the NA 10 in common.

As an example, it is assumed that the user U1 is a doctor and the user U2 is a patient, and they have different medical knowledge levels. In this case, when providing them with identical information (a search result), the processing system 1 provides the doctor with the information using a highly-professional expression (expression data) whereas the processing system 1 provides the patient with the information using an expression understandable without having medical knowledge. In this way, the processing system 1 in the embodiment can provide a user with information using an expression fitting the user's knowledge level.

When the user U1 says “I set up DNS” and the user U2 asks the user U1 “What is DNS?”, the NA 10 can receive the contents explaining “DNS” from the web cloud as the search result and provide the user U2 with the contents. That is, the processing system 1 can explain “DNS” to the user U2 instead of the user U1.

As illustrated in FIG. 1, the NA 10 includes a voice input unit 11, a global positioning system (GPS) receiving unit 13, a communication unit 15, an imaging unit 16, a storage unit 17, an output unit 19, and a control unit 20.

The voice input unit 11 inputs a voice of the user and/or the like to the NA 10, and can be realized by a sound collector such as a microphone. The GPS receiving unit 13 receives positional information indicating a location of the user. Specifically, the GPS receiving unit 13 receives radio waves from GPS satellites and can be realized by a GPS receiver or the like.

The communication unit 15 communicates with an external apparatus such as the search server 101 through the Internet 107 and can be realized by a communication device such as a network interface card (NIC). The imaging unit 16 images a surrounding environment of the user of the NA 10 and can be realized by an imaging device such as a digital camera or a stereo camera.

The storage unit 17 stores therein various programs executed by the NA 10 and data used for various types of processing performed by the NA 10. The storage unit 17 can be realized by a storage device capable of magnetically, optically or electrically storing data, such as a hard disk drive (HDD), a solid state drive (SDD), a memory card, an optical disk, a read only memory (ROM), or a random access memory (RAM).

The output unit 19 outputs a processing result of the control unit 20 and may be realized by a display device for visual output such as a liquid crystal display or a touch panel display, an audio device for audio output such as a speaker, or the combination of the devices. The control unit 20 controls the respective units of the NA 10.

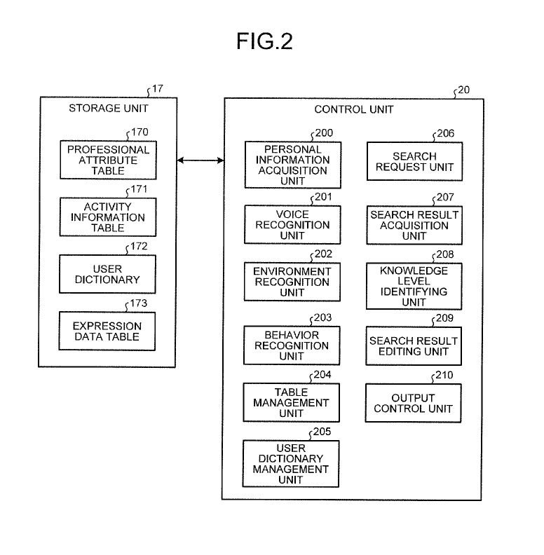

FIG. 2 is a block diagram illustrating detailed functional structures of the storage unit 17 and the control unit 20. The control unit 20 includes a personal information acquisition unit 200, a voice recognition unit 201, an environment recognition unit 202, a behavior recognition unit 203, a table management unit 204, a user dictionary management unit 205, a search request unit 206, a search result acquisition unit 207, a knowledge level identifying unit 208, a search result editing unit 209, and an output control unit 210.

The personal information acquisition unit 200, the voice recognition unit 201, the environment recognition unit 202, the behavior recognition unit 203, the table management unit 204, the user dictionary management unit 205, the search request unit 206, the search result acquisition unit 207, the knowledge level identifying unit 208, the search result editing unit 209, and the output control unit 210 may be realized by causing a processing unit such as a central processing unit (CPU) to execute a computer program, i.e., realized by software, by hardware such as an integrated circuit (IC), or by both of the software and the hardware.

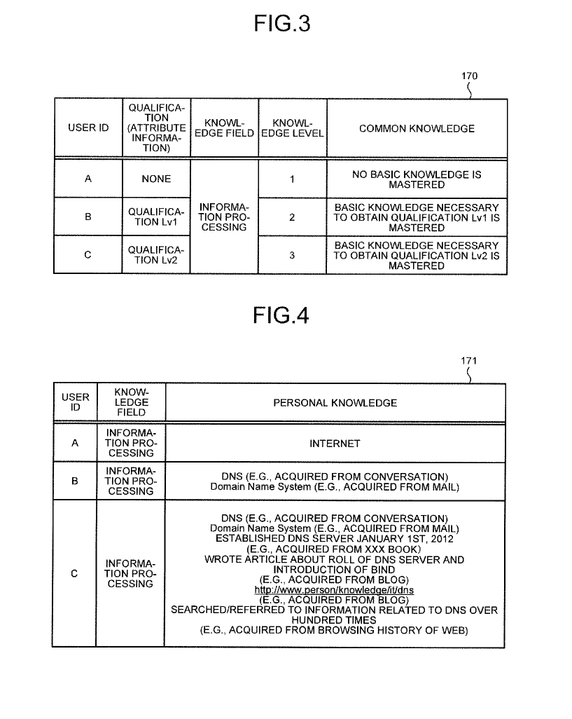

The storage unit 17 includes a professional attribute table 170, an activity information table 171, a user dictionary 172, and an expression data table 173. FIG. 3 is a schematic diagram illustrating a data structure of the professional attribute table 170. The professional attribute table 170 stores therein knowledge of the user. For example, the knowledge of the user is expert knowledge in a certain field such as information processing or medicine. The professional attribute table 170 stores therein a knowledge field of a user and a knowledge level that is an index of how much knowledge the user has in a predetermined knowledge field so as to be associated with the user.

Specifically, as illustrated in FIG. 3, the professional attribute table 170 stores therein a user ID identifying a user, and a qualification, the knowledge field, and common knowledge that the user has, so as to be associated with each other.

The common knowledge indicates knowledge that the user in each knowledge level may have. That is, the common knowledge is data determined in accordance with the knowledge level. Pieces of the common knowledge corresponding to the respective knowledge levels are preliminarily stored in the storage unit 17 by a designer or the like, so as to be associated with the respective knowledge levels. For example, when the knowledge level corresponds to a certain qualification, the common knowledge corresponding to the knowledge level may be prepared with reference to a guide line for acquiring the qualification and past tests and handbooks of the qualification test, and registered on the storage unit 17. For example, a user who has a “qualification Lvl” is deemed to understand “DNS” and “host name” and such information is registered on the storage unit 17 as the common knowledge corresponding to the “qualification Lvl”.

The data structure of the professional attribute table 170 illustrated in FIG. 3 is an example. As another example, a table may be provided in which the knowledge fields, the knowledge levels, and the common knowledge are stored so as to be associated with each other independent from the professional attribute table 170, and the professional attribute table 171 may store therein the user IDs, the qualifications, the knowledge fields, and the knowledge levels so as to be associated with each other.

Like this, any data structure that can identify the knowledge level of a user in a predetermined knowledge field and identify the common knowledge in the identified knowledge level on the basis of the user ID is applicable as the professional attribute table 170. The number of tables may be one or more than one.

FIG. 4 is a schematic diagram illustrating a data structure of the activity information table 171. The activity information table 171 stores therein knowledge that the user obtains through the user's activity for each user. Specifically, as illustrated in FIG. 4, the activity information table 171 stores therein the knowledge field and personal knowledge as the activity knowledge so as to be associated with the user ID.

The personal information indicates knowledge that the user actually obtains from conversation, mails, Facebook, or the like. The common knowledge indicates knowledge that a user is objectively supposed to have on the basis of the qualification that the user has, whereas the personal knowledge indicates knowledge that a user actually has. That is, the common knowledge indicates knowledge that the users who have equal knowledge levels are supposed to have in common, whereas the personal knowledge indicates knowledge that varies between users.

When the user having a user ID “A” associated with knowledge level 1 in the professional attribute table 170 illustrated in FIG. 3, understands “Internet”, “Internet” is registered as the personal knowledge of the user on the activity information table 171 as illustrated in FIG. 4.

The personal knowledge is stored so as to be associated with the knowledge field to which the personal knowledge belongs. For example, technical terms in information processing such as the “Internet” and a “domain name system (DNS)” are stored in the activity information table 171 so as to be associated with the knowledge field of the “information processing”.

The professional attribute table 170 and the activity information table 171 are registered and updated accordingly by the control unit 20. Processing to register and update the professional attribute table 170 and the activity information table 171 is described later.

The user dictionary 172 stores therein, for each user, knowledge data that the user has, such as the common knowledge and the personal knowledge, information relating to the user, and/or the like. The user dictionary 172 is produced by the control unit 20 with reference to the professional attribute table 170 and the activity information table 171. The user dictionary 172 is described later.

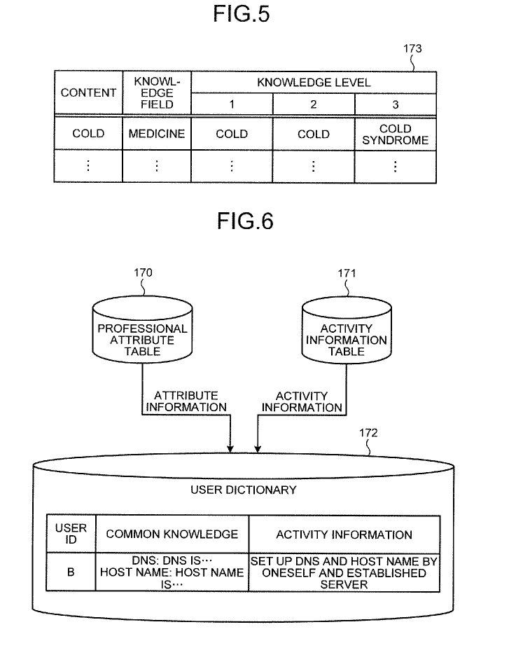

FIG. 5 is a schematic diagram illustrating a data structure of the expression data table 173. The expression data table 173 stores therein a plurality of pieces of expression data expressing identical contents in different expressions so as to be associated with different knowledge levels for each knowledge field. Specifically, the expression data table 173 stores therein the plurality of pieces of expression data expressing identical contents in expressions different between the knowledge levels so as to be associated with the knowledge field and the respective knowledge levels.

For example, as for contents of “cold”, the expression data of “cold” is associated with knowledge level 1 corresponding to a patient while the expression data of “cold syndrome” is associated with knowledge level 3 corresponding to a doctor.

The plurality of pieces of expression data expressing identical contents are preliminarily registered on the expression data storage unit 173 by a designer or the like, so as to be associated with respective knowledge levels determined as appropriate. The expression data and the corresponding relation between the expression data and the knowledge level in the expression data storage unit 173 may be updated accordingly by the control unit 20 or the like.

Referring back to FIG. 2, the personal information acquisition unit 200 of the control unit 20 acquires information relating to the user externally. The personal information is used for registration and updating of the professional attribute table 170.

Specifically, the personal information acquisition unit 200 acquires attribute information of the user from a device such as a cellular phone that the user possesses. Examples of the attribute information include user's name, age, sex, hobby, nationality, educational background, career, and relevant information. The hobby includes a detailed hobby for each field such as literature, music, entertainment, and sport. The nationality includes an address including the country and a working language. The educational background includes a university, a subject, a license, and a qualification. The career includes an occupation, a place of work, and the address of the place of work. The relevant information includes information relating to an organization to which the user belongs, volunteer activities, and friendship.

The personal information acquisition unit 200 acquires activity related information related to an activity of the user. Specifically, the personal information acquisition unit 200 acquires mails transmitted and received by the user and contents of phone calls from the mobile phone of the user or the like as the activity related information. The personal information acquisition unit 200 acquires blogs, social networking services (SNSs) such as Facebook and mixi, and tweets in twitter and mixi voice browsed or made by the user with the device of the user. The personal information acquisition unit 200 further acquires the contents of conversation of the user as the activity related information. The contents of conversation are acquired from the voice recognition result of the voice recognition unit 201 or the like.

The voice recognition unit 201 performs voice recognition processing on an input voice and obtains the voice recognition result. Specifically, the voice recognition unit 201 extracts a feature value of a voice input from the voice input unit 11 and converts the extracted feature value into a text (character string) using dictionary data for voice recognition stored in the storage unit 17 or the like. The detailed description of the voice recognition technique is omitted because known techniques disclosed in such as Japanese Patent Application Laid-open No. 2004-45591 and Japanese Patent Application Laid-open No. 2008-281901 can be used as the voice recognition technique.

The environment recognition unit 202 recognizes external conditions. The external conditions are the conditions of the environment where the user is present, such as a current location of the user, weather, temperature, and time. The environment recognition unit 202 recognizes the current location of the user of the NA 10 using radio waves from GPS satellites received by the GPS receiving unit 13. The environment recognition unit 202 requests the search request unit 206, which is described later, to search the web for weather, temperature, or time on the basis of the recognized current location of the user, and recognizes the weather, the temperature, or the time at the current location of the user from the search result of the web search acquired by the search result acquisition unit 207, which is described later.

The behavior recognition unit 203 recognizes behaviors of the user on the basis of detection results of detection sensors such as the GPS receiving unit 13 and the imaging unit 16, information externally input, and the information stored in the storage unit 17, for example.

The behavior recognition unit 203 recognizes the behaviors such as “the user stretches the user's hand”, “the user stands up”, “the user starts walking”, and “the user inclines the user's head” on the basis of the image of the user taken by the imaging unit 16. Examples of such a gesture recognition technique are disclosed in Japanese Patent No. 4031255 and Japanese Patent No. 4153818. The behavior recognition unit 203 recognizes the behavior such as “the user is walking” or “the user is on a train” on the basis of a temporal change in the positional information received by the GPS receiving unit 13.

The behavior recognition unit 203 discriminates between transfer by train and walking on the basis of a moving velocity obtained from the temporal change in the positional information received by the GPS receiving unit 13. The behavior recognition unit 203 may identify whether the moving route is on the road or the rail line by comparing the positional information with map information stored in the storage unit 17. As a result, the behavior recognition unit 203 can discriminate between transfer by train and walking. The behavior recognition unit 203 may discriminate between transfer by train and walking using a surrounding image taken by the imaging unit 18 and on the basis of the determination whether the image is of that in a train.

The behavior recognition unit 203 recognizes that “persons are having a conversation” when voices of a plurality of persons are input on the basis of the voices input to the voice input unit 11. The behavior recognition unit 203 may determine whether “persons are having a conversation” by further taking into consideration whether an image taken by the imaging unit 16 includes a plurality of persons.

When recognizing the behavior of “the user inclining the user's head” together with the voice recognition result of “I don't understand” obtained by the voice recognition unit 201, the behavior recognition unit 203 integrates both results and recognizes the integrated result as the behavior of the user. As for the integral recognition of voices and gestures, refer to Japanese Unexamined Patent Application Publication (translation of PCT Application) No. 2010-511958, for example.

The behavior recognition unit 203 recognizes that “the user reaches over and grabs an orange” on the basis of the image of the user taken by the imaging unit 16. Specifically, when the behavior recognition unit 203 detects the movement of the user's hand in a direction away from the user's body from the captured moving image or still images in time series of the user, and additionally detects an orange at a position toward which the user's hand is moving, the behavior recognition unit 203 recognizes that “the user reaches over and grabs an orange”. In the way described here, the voice input unit 11, the GPS receiving unit 13, and the imaging unit 16 function as the detection sensors detecting the external conditions.

The table management unit 204 registers information on and updates information of the professional attribute table 170, the activity information table 171, and the expression data table 173 that are stored in the storage unit 17.

Specifically, the table management unit 204 registers the qualification that the user has, and the user's knowledge field, knowledge level, and common knowledge on the professional attribute table 170 so as to be associated with the user ID on the basis of the attribute information acquired by the personal information acquisition unit 200.

The table management unit 204 registers the user's activity information on the activity information table 171 on the basis of the activity related information acquired by the personal information acquisition unit 200 and the recognition results of the voice recognition unit 201, the environment recognition unit 202, and the behavior recognition unit 203. For example, when the term “domain name system” is included in a mail that the user identified by the user ID “C” sent, the table management unit 204 registers this on the activity information table 171 as the personal knowledge so as to be associated with the user ID “C”. When the term “DNS” is obtained from the voice recognition result of the conversation of the user identified by the user ID “C”, the table management unit 204 registers this on the activity information table 171 as the personal knowledge so as to be associated with the user ID “C”.

The table management unit 204 may produce statistical information of history, such as that a user searches for or references to information related to DNS over a hundred times, and register the statistical information on the activity information table 171 as the personal knowledge.

The personal information acquisition unit 200 may periodically acquire the personal information and, each time the personal information acquisition unit 200 acquires the personal information, the table management unit 204 may update accordingly the professional attribute table 170 and the activity information table 171 on the basis of the acquired personal information.

The user dictionary management unit 205 produces the user dictionary for each user with reference to the professional attribute table 170 and the activity information table 171. Specifically, the user dictionary management unit 205 acquires the attribute information of the user from the professional attribute table 170. The user dictionary management unit 205 acquires the common knowledge corresponding to the acquired attribute information and registers the acquired common knowledge on the user dictionary. The user dictionary management unit 205 acquires the personal knowledge from the personal knowledge table 171 and registers the acquired personal information on the user dictionary.

FIG. 6 is a schematic diagram to explain the processing performed by the user dictionary management unit 205. With reference to FIG. 6, the following describes the processing to produce the user dictionary of the user identified by the user ID “B” (hereinafter, referred to as the user B) in relation to “DNS”. Here, the term “DNS” belongs to the knowledge field of the information processing and it is assumed that the user B has a qualification Lvl, which is the qualification in the knowledge field of the information processing.

The user dictionary management unit 205 refers to the professional attribute table 170 and acquires the qualification, the knowledge level, and the common knowledge associated with the knowledge field of the “information processing” and the user ID “B”. The user dictionary management unit 205 registers information relating to “DNS” and “host name”, which are deemed to be understood by the user having the “qualification Lvl”, in the user dictionary of the user B as the common knowledge because the user B has the “qualification Lvl”.

The user dictionary management unit 205 refers to the activity information table 171 and acquires a piece of the personal knowledge relating to “DNS” among the personal knowledge associated with the knowledge field of the “information processing”. The user dictionary management unit 205 produces the user dictionary 172 on the basis of the acquired information and stores the user dictionary 172 in the storage unit 17.

As a result, the user dictionary is produced as illustrated in FIG. 6, which includes the common knowledge relating to “DNS” associated with the qualification that the user identified by the user ID “B” has, and the activity information relating to “DNS” so as to be associated with the user ID “B”. When the number of accesses or experiences relating to certain activity information is large, it can be assumed that the user's experience with the activity information is profound.

The search request unit 206 acquires the voice recognition result obtained by the voice recognition unit 201 and behavior recognition result obtained by the behavior recognition unit 203, and makes a request to search information on the basis of the acquired results. For example, when acquiring the condition recognition result of “the user grabbing an orange” and the voice recognition result of “I want to know the freshness date”, the search request unit 206 requests the search server 101 to perform a web search with the search query of “the freshness date of an orange”. The search request unit 206 refers to the user dictionary 172 and requests the search server 101 to find a search result including difference from the information registered on the user dictionary 172. The search result acquisition unit 207 acquires a search result corresponding to the search query from the search server 101 through the communication unit 15.

The knowledge level identifying unit 208 identifies the user's knowledge level in the knowledge field to which the contents of the search result acquired by the search result acquisition unit 207 belong. Herein, the user is a provision destination user to whom the search result is to be provided.

Specifically, the knowledge level identifying unit 208 extracts the expression data registered on the expression data table 173 on the basis of the search result and identifies the knowledge field associated with the extracted expression data. Then, the knowledge level identifying unit 208 refers to the professional attribute table 171 and identifies the knowledge level of the provision destination user in relation to the identified knowledge field.

The search result editing unit 209 refers to the expression data table 173 and changes the expression of the contents included in the search result to the expression corresponding to the knowledge level of the provision destination user.

Specifically, the search result editing unit 209 refers to the expression data table 173 and extracts the expression data that indicates the same contents as the expression data included in the search result and is associated with the knowledge level of the provision destination user. Then, the search result editing unit 209 edits the search result using the extracted expression data.

For example, it is assumed that the term “cold” is obtained as a result of searching performed by the user having knowledge level “3” in the knowledge field of medicine. In this case, the search result editing unit 209 refers to the professional attribute table 170 and identifies the knowledge level of the user in the knowledge field of medicine on the basis of the user ID. Further, the search result editing unit 209 refers to the expression data table 173 and extracts “cold syndrome”, which is the expression data corresponding to “cold” and is associated with the knowledge level of “3” in the knowledge field of medicine.

The output control unit 210 causes the output unit 19 to output the search result after being edited by the search result editing unit 209 at appropriate timing. For example, when causing the output unit 19 to output a voice, the output control unit 210 converts an answer sentence corresponding to the search result after being edited by the search result editing unit 109 into a voice by voice synthesis and causes the output unit 19 to output the voice. For another example, when causing the output unit 19 to display an image on a display screen, the output control unit 210 converts an answer sentence into image drawing data and causes the output unit 19 to display the image on the screen. When it is determined that output is to be performed using an external apparatus, the output control unit 210 transmits an answer sentence (search result) to the designated external apparatus through the communication unit 15. In this case, the search result is output by the designated external apparatus in a designated output format.

The output control unit 210 determines output timing on the basis of the behavior recognition result and/or the condition recognition result. For example, when the condition recognition result of the user uttering something is obtained, the output control unit 210 determines the completion of the utterance as the output timing and outputs an answer sentence of the search result after the completion of the utterance. An algorithm for determining the output timing on the basis of the behavior recognition result and/or the condition recognition result or a table in which the condition recognition result and a control manner of the output timing are included so as to be associated with each other is preliminarily stored in the storage unit 17. The output control unit 210 determines the output timing using the algorithm or the table.

All of the above units are not indispensable for the NA 10, and a part of the units may be omitted.

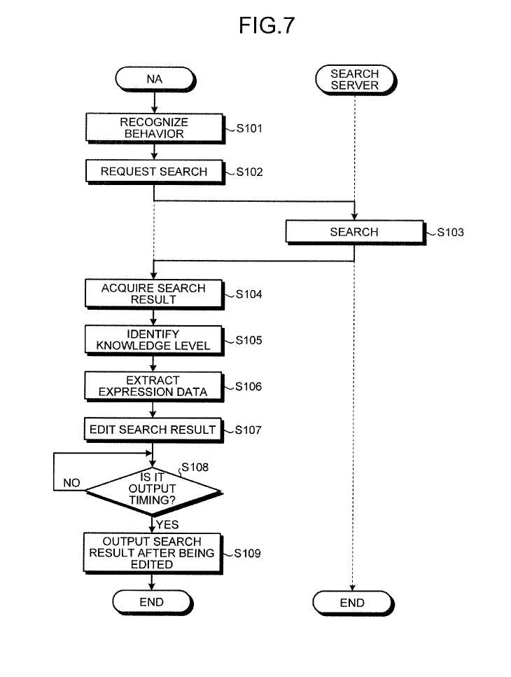

The operation of the processing system 1 in the embodiment is described below. FIG. 7 is a flowchart illustrating an example of first search processing performed by the processing system 1 in the embodiment. The NA 10 always recognizes the behavior of the user (step S101). Specifically, the voice recognition unit 201 performs voice recognition processing each time a voice is input to the voice input unit 11 and the environment recognition unit 202 always recognizes the behavioral condition of the user. The search request unit 206 produces a search query on the basis of the recognition results obtained by the voice recognition unit 201 and the behavior recognition unit 202 and requests the search server 101 to perform a search (step S102).

The search server 101 receives the search query from the NA 10, searches information published on the web in accordance with the received search query, and transmits the search result to the NA 10 (step S103).

The search result acquisition unit 207 acquires the search result of the information from the search server 101 (step S104). Next, the knowledge level identifying unit 208 refers to the expression data table 173 and identifies the expression data included in the search result, and additionally refers to the professional attribute table 170 and identifies the user's knowledge level in the knowledge field to which the expression data belongs (step S105).

The search result editing unit 209 edits the search result (step S107). Specifically, the search result editing unit 209 refers to the expression data table 173 and extracts the expression data that has the same contents as a keyword included in the search result and is associated with the user's knowledge level, and edits the search result using the extracted expression data.

Next, the output control unit 210 determines whether it is the output timing on the basis of the condition recognition result. If it is determined that it is the output timing (Yes at step S108), the search result after being edited is output (step S109). If it is determined that it is not the output timing (No at step S108), the processing returns to step S108, and a wait is made until the output timing. Then, the processing ends.

For example, it is assumed that a search result including the expression data “cold syndrome” is obtained as the search result to be provided to a patient in a conversation between the patient and a doctor. In this case, the search result editing unit 209 refers to the expression data table 173 and extracts the expression data “cold”, which expresses the same contents as “cold syndrome” and is associated with knowledge level 1 (the knowledge level of the patient). The search result editing unit 209 obtains the data in which “cold syndrome” included in the search result is replaced with “cold” as the search result after being edited.

As a result, the processing system 1 can play a role of explaining the meaning of “cold syndrome” instead of the doctor. On the other hand, the processing system 1 can provide the doctor with the search result using the technical term.

In this way, the processing system 1 in the embodiment can provide a user with the contents of the search result in the expression fitting the knowledge level of the provision destination user to whom the search result is to be provided.

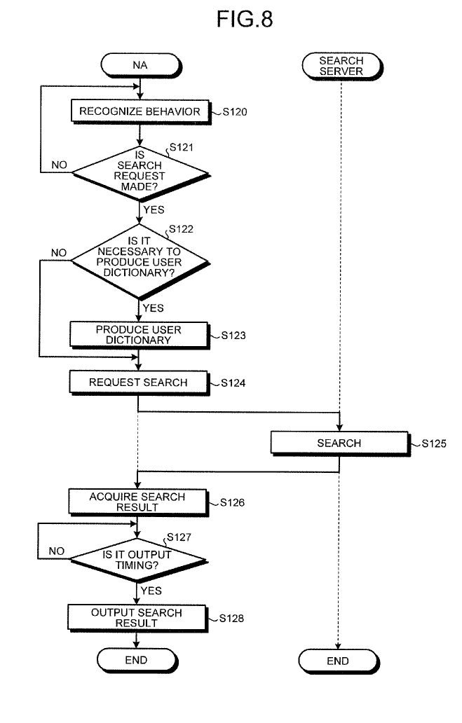

FIG. 8 is a flowchart illustrating an example of second search processing performed by the processing system 1 in the embodiment. Although, in the first search processing, the expression data included in the search result is changed so as to fit the knowledge level of the user to whom the search result is provided, in the second search processing, a search result fitting the knowledge level of the user to whom the search result is to be provided, is acquired and the acquired search result is provided to the user.

For example, when the search result including the term “DNS” is provided and the utterance of “I don't understand” of the user is obtained as the voice recognition result in the first search processing, the second search processing is performed.

In the second search processing, the NA 10 always recognizes the behavior of the user (step S120). For example, when recognizing the explanation of “DNS” is requested as described above, the search request unit 206 determines that a search request is made. If it is determined that no search request is made (No at step S121), the processing returns to step S120, and recognition of the behavior of the user is continued.

If it is determined that a search request is made (Yes at step S121), the user dictionary management unit 205 determines whether the user dictionary needs to be newly produced for the user to whom the search result is provided.

The user dictionary management unit 205 determines that the user dictionary needs to be produced when the user dictionary relating to “DNS” is not registered. Even when the user dictionary relating to “DNS” is registered, when the contents registered on the professional attribute table 170 or the activity information table 171 in relation to the provision destination user are changed thereafter, the user dictionary management unit 205 determines that the user dictionary needs to be produced (restructured). This is because the change in the professional attribute table 170 or the activity information table 171 needs to be reflected in the user dictionary.

If the user dictionary management unit 205 determines that the user dictionary needs to be produced (Yes at step S122), the user dictionary management unit 205 refers to the professional attribute table 170 and the activity information table 171 for the provision destination user, and produces the user dictionary of the provision destination user in relation to “DNS” (step S123).

Next, the search request unit 206 produces a search query on the basis of the behavior recognition results obtained by the voice recognition unit 201 and the environment recognition unit 202 and requests the search server 101 to perform a search (step S124). At this time, the search request unit 206 refers to the user dictionary 173 for the provision destination user produced by the user dictionary management unit 205, and requests information including information that the provision destination user lacks while excluding information that the provision destination user already knows.

Subsequently, the search server 101 receives the search query from the NA 10, searches information published on the web in accordance with the received search query, and transmits the search result to the NA 10 (step S125).

Subsequently, the search result acquisition unit 207 acquires the search result of the information from the search server 101 (step S126). Next, the output control unit 210 determines whether it is the output timing on the basis of the condition recognition result. If it is determined that it is the output timing (Yes at step S127), the search result after being edited is output (step S128). Then, the processing ends.

For example, it is assumed that the user dictionary illustrated in FIG. 6 is produced as the user dictionary for a provision destination user. In this case, the provision destination user has knowledge about “host name” but does not have knowledge about “IP address” as can be seen from the user dictionary. Accordingly, the search request unit 206 excludes the search result including the explanation of “host name” and preferentially searches information including the explanation of “IP address”.

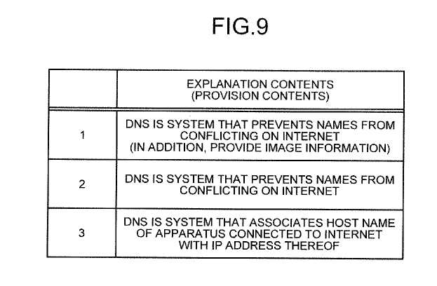

FIG. 9 is a schematic diagram illustrating examples of the contents of the explanation of “DNS” obtained as the search result. Like this, different explanation contents can be provided to the provision destination user in accordance with the knowledge level or the activity information of the provision destination user.

As another example, information including the contents that the user knows and the contents that the user does not know may be preferentially searched. In such a case, when the provision destination user has knowledge about “host name” but does not have knowledge about “IP address” as described above, the contents of the explanation illustrated at “3” in FIG. 9 may be provided to the user.

In this way, the processing system 1 in the embodiment refers to the user's attribute information and the user's activity information registered on the user dictionary, and searches the contents capable of supplementing the information that the user lacks. As a result, the processing system 1 can provide the user with the supplemented information.

The embodiment described above can be changed or modified in various ways.

As a first modification of the embodiment, the table management unit 204 may register or update the knowledge levels of the respective users in the professional attribute table 170 on the basis of the personal information acquired by the personal information acquisition unit 200, the voice recognition results of the voice recognition unit 201, the behavior recognition results of the behavior recognition unit 203, or the like.

The table management unit 204 may identify the knowledge level of the user in a predetermined knowledge field comprehensively on the basis of not only the personal information acquired by the personal information acquisition unit 200 but also the recognition results of the voice recognition unit 201, the environment recognition unit 202, and the behavior recognition unit 203.

For example, when the behavior recognition unit 203 can identify that a doctor and a patient are having a conversation and determine that one user is the doctor on the basis of the personal information, the table management unit 204 may identify the other user as the patient.

For another example, when it is identified that a user goes to a medical office of a hospital every day on the basis of the recognition result of the behavior recognition unit 203, the table management unit 204 can identify the user as a medical service worker. In addition, the detailed occupation, e.g., a nurse or a doctor, can be identified on the basis of a presence or an absence of medical practice performed by the user or the like. The table management unit 204 may register the knowledge level of the user in a knowledge field related to the user's occupation on the professional attribute table 170 on the basis of the identified occupation. As a result, the processing can be eliminated that is performed by a designer to preliminarily register the knowledge level of each user on the professional attribute table 170.

As a second modification of the embodiment, the table management unit 204 may dynamically change the knowledge level of each user on the basis of response information from the user during conversation between the user and the processing system 1. For example, even if set to a relatively low knowledge is set to a user, when a lot of expert knowledge is newly registered on the activity information table 171 for the user on the basis of conversation in a certain field, the knowledge level of the user may be raised regardless of possession or non-possession of qualifications and the attribute information.

In contrast, when, on the basis of the contents of questions of a user in a conversation, it is determined that a user does not have the common knowledge corresponding to the knowledge level set on the basis of possession or non-possession of qualifications, the knowledge level of the user may be lowered.

As a third modification of the embodiment, the behavior of the provision destination user obtained when the search result is output in the first and the second search processing may be fed back to the professional attribute table 170, the activity information table 171 and/or the expression data table 173.

For example, when the search result is provided and the provision destination user's utterance of “I don't understand” is obtained, in the processing system 1, the table management unit 204 may perform a feedback such as changing the knowledge level of the provision destination user registered on the professional attribute table 170 to a lower level or changing a corresponding relation between the expression data and the knowledge level in the expression data table 173. The behavior of the provision destination user that is the target of the feedback, i.e., the behavior of a user who is not provided with the expression data desired by the user, is preliminarily registered on the storage unit 17. The table management unit 204 performs the feedback when the behavior recognition result corresponding to the behavior registered on the storage unit 17 is obtained.

For another example, when the search result is provided to a provision destination user and the provision destination user's utterance indicating that the contents of the result is what the user already knows is obtained, in the processing system 1, the table management unit 204 may newly register the contents of the search result on the expression data table 173 as the activity information of the provisi destination user.

The NA 10 in the embodiment has a normal hardware structure utilizing a computer. The NA 10 includes a control unit such as a CPU, a storage device such as a ROM and a RAM, an external storage device such as an HDD and a compact disk (CD) drive, a display device such as a display, and an input device such as a keyboard or a mouse.

The program executed by the NA 10 in the embodiment is recorded into a computer readable recording medium as a file in an installable format or an executable format, and provided. Examples of the recording medium include CD-ROMs, flexible disks (FDs), CD-recordables (CD-Rs), and digital versatile disks (DVDs).

The program executed by the NA 10 in the embodiment may be stored in a computer coupled with a network such as the Internet, and be provided by being downloaded through the network. The program executed by the NA 10 in the embodiment may be provided or delivered through a network such as the Internet. The program in the embodiment may be provided by being preliminarily stored in the ROM, for example.

The program executed by the NA 10 in the embodiment has a module structure including the above-described units (the behavior recognition unit, the environment recognition unit, the search request unit, the search result acquisition unit, the provision manner determination unit, and the output control unit). In actual hardware, the CPU (processor) reads the program from the storage medium and executes the program. Once the program is executed, the above-described units are loaded into a main storage, so that the units are formed in the main storage.

The embodiment can provide an advantage of providing the user with information in an expression fitting the user's knowledge level.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A processing apparatus, comprising:
a voice recognition unit that recognizes a voice of a user;
a search result acquisition unit that acquires a search result searched on the basis of the voice recognized by the voice recognition unit;
a user data storage unit that stores therein a knowledge level in a predetermined knowledge field so as to be associated with a user;
an expression data storage unit that stores therein a plurality of pieces of expression data expressing provision contents provided to the user as the search result so as to be associated with a plurality of different knowledge levels, the plurality of pieces of expression data having different professional levels regarding the provision contents;
a knowledge level identifying unit that identifies a knowledge level of the user with reference to the user data storage unit;
an editing unit that edits the search result on the basis of the expression data associated with the knowledge level identified by the knowledge level identifying unit in the expression data storage unit and expressing the provision contents included in the search result acquired by the search result acquisition unit; and
an output unit that outputs the search result after being edited by the editing unit.

2. The processing apparatus according to claim 1, further comprising:
a personal information acquisition unit that externally acquires personal information of a user; and
a knowledge level register that determines the knowledge level of the user on the basis of the personal information, and registers the determined knowledge level on the user data storage unit so as to be associated with the user.

3. The processing apparatus according to claim 1, further comprising:
a behavior recognition unit that recognizes behavior of a user on the basis of information acquired externally; and
a knowledge level register that determines the knowledge level of the user on the basis of the behavior of the user recognized by the behavior recognition unit, and registers the determined knowledge level on the user data storage unit so as to be associated with the user.

4. The processing apparatus according to claim 1, further comprising:
a behavior recognition unit that recognizes behavior of a user after the output unit outputs the search result; and
a knowledge level changing unit that changes the knowledge level of the user stored in the user data storage unit when the behavior of the user recognized by the behavior recognition unit is coincident with registered behavior preliminarily registered as behavior of a user in a case that expression data desired by the user is not provided.

5. The processing apparatus according to claim 1, further comprising:
a behavior recognition unit that recognizes behavior of a user after the output unit outputs the search result; and
a knowledge level changing unit that changes, when the behavior of the user recognized by the behavior recognition unit is coincident with registered behavior preliminarily registered as behavior of a user in a case that expression data desired by the user is not provided, a knowledge level associated with the expression data in the search result corresponding to the registered behavior in the expression data storage unit.

6. A processing system, comprising:
a voice recognition unit that recognizes a voice of a user;
a search result acquisition unit that acquires a search result searched on the basis of the voice recognized by the voice recognition unit;
a user data storage unit that stores therein a knowledge level in a predetermined knowledge field so as to be associated with a user;
an expression data storage unit that stores therein a plurality of expressions expressing provision contents provided to the user as the search result so as to be associated with a plurality of different knowledge levels, the plurality of pieces of expressions having different professional levels regarding the provision contents;
a knowledge level identifying unit that identifies a knowledge level of the user with reference to the user data storage unit;
an editing unit that edits the search result on the basis of expression data associated with the knowledge level identified by the knowledge level identifying unit in the expression data storage unit and expressing the provision contents included in the search result acquired by the search result acquisition unit; and
an output unit that outputs the search result after being edited by the editing unit.

7. An output method performed by a processing apparatus that includes a user data storage unit that stores therein a knowledge level in a predetermined knowledge field so as to be associated with a user, and an expression data storage unit that stores therein a plurality of expressions expressing the provision contents provided to the user so as to be associated with a plurality of different knowledge levels, the plurality of expressions having different professional levels regarding provision contents, the output method comprising:
recognizing a voice of a user;
acquiring a search result searched on the basis of the voice recognized at the recognizing;
identifying a knowledge level of the user with reference to the user data storage unit;
editing the search result on the basis of the expression data that is associated with the knowledge level identified at the identifying in the expression data storage unit and expresses the provision contents included in the search result acquired at the acquiring; and
outputting the search result after being edited at the editing.
